(19) United States
(12) Patent Application Publication
(10) Pub. No.: US 2012/0304224 A1
(43) Pub. Date: Nov. 29, 2012

(54) Mechanism for Embedding Metadata in Video and Broadcast Television

(76) Inventor: Steven Keith Hines, San Francisco, CA (US)

(21) Appl. No.: 13/171,311

(22) Filed: Jun. 28, 2011

Related U.S. Application Data
(60) Provisional application No. 61/489,999, filed on May 25, 2011.

(51) Int. Cl. H04N 21/43

(52) U.S. Cl. 725/34

(57) ABSTRACT

A video stream is displayed on a display. A particular image displayed in the video stream is detected. A string associated with the detected particular image is determined. A request including the determined string associated is sent to a server. A set of instructions relating to the string is received. The set of instructions includes instructions to execute an application and to display the application concurrently with the video stream. An application is executed in accordance with the set of instructions in response to receiving the set of instructions.

### RELATED APPLICATIONS

This application claims priority to U.S. Provisional Application Ser. No. 61/489,999, filed May 25, 2011, entitled “Mechanism for Embedding Metadata in Video and Broadcast Television”, which is incorporated by reference herein in its entirety.

### TECHNICAL FIELD

The present description relates generally to providing information a user.

### BACKGROUND

Video content sometimes includes audio and visual messages that prompt viewers to obtain more information relating to the content of the video. For example, a television commercial may prompt a user visit a product's website to obtain more information about the product. In another example, during the broadcast of a television program or movie, a message may appear prompting a viewer to visit a website to view more information about the people, places or things in the television program or movie. Even without being prompted to, many users are interested in a person, place or thing related to the video content they are currently watching. Typically, to obtain the additional information, a user is required to visit a website using an internet accessible device. Existing methods are inefficient because they require users to take some action. Many viewers may miss or ignore audio and visual messages and it may be inconvenient for many viewers to operate a computing device while viewing video content.

### SUMMARY

The methods and systems described herein disclose systems and methods for inserting metadata into video streams. Such methods and systems provide an effective way for broadcasters and content providers to provide information and services to users. At a server, metadata is encoded into an image such as a bar code. The encoded image is inserted at a particular display position in a consecutive number of frames of a video stream. For example, the encoded image may be placed in the upper right corner of 30 consecutive frames of a video stream. The modified video stream is transmitted to a client device for display. While the video stream is displayed, the client device detects the encoded image in the video stream, decodes the image to obtain a string and sends a request containing the string to a server. The server generates a set of instructions based on the string and sends the set of instructions to the client device for execution.

In accordance with some implementations, systems and methods are provided to insert metadata into video streams. A video stream is prepared for transmission at a server. The preparing includes inserting a particular image into the video stream, thereby forming a modified video stream. The particular image is associated with a string. The modified video stream is formatted to concurrently display the video stream and the particular image. The modified video is transmitted to a client device.

The methods and systems described herein provide an effective way for broadcasters and content providers to provide information and services to users. For example, a user may view a commercial about tea that includes one or more bar codes and while the user is viewing the commercial, a module on the client device detects one or more encoded images in the video stream, decodes the one or more encoded images to obtain a string, sends a request to a server containing the string, obtains a set of instructions from the server and performs one or more functions in accordance with the set of instructions. In this example, the set of instructions may execute one or more applications such as a browser to display a web page with information about a particular type or brand of tea, a media player to show an instructional video on preparing tea, a feed reader application to display items on tea from a particular feed source, or a coupon book application to present coupons for the tea that was the subject of the commercial. The one or more applications are executed while the commercial is being displayed and the one or more applications are displayed concurrently with the commercial.

In accordance with some implementations, systems and methods are provided to display information. A video stream is displayed on a display of a client device. A particular image within the video stream is detected and a string associated with the particular image is determined. A request including the determined string is sent to a server. A set of instructions relating the string is received. The set of instructions include instructions to execute an application and to display the application concurrently with the video stream. One or more applications are executed in accordance with the set of instructions in response to receiving the set of instructions.

In accordance with some implementations, at a client device having one or more processors and memory storing one or more programs to be executed by the one or more processors: a method is performed that includes: detecting a particular image within a video stream; determining a string associated with the detected particular image; sending a request to a server, the request including the determined string; receiving a set of instructions from the server in response to sending the request, the set of instructions relating to the determined string, wherein the set of instructions includes instructions to execute an application; and in response to receiving the set of instructions, executing the application in accordance with the set of instructions and causing the application to be displayed concurrently with the video stream.

In accordance with some implementations, at a server, a request is received from a client. The request includes a string that was extracted from a particular image that is in a predefined number of consecutive video frames of a video stream. A set of instructions associated with the string is generated in response to receiving the request. The set of instructions include instructions to execute an application and to concurrently display the application with a video stream. The set of instructions is sent to the client.

### BRIEF DESCRIPTION OF THE DRAWINGS

FIG. 1 is a block diagram illustrating a distributed client-server system in accordance with some implementations.

FIG. 2A is a block diagram illustrating the structure of an exemplary server system according to some implementations.

FIG. 2B is a block diagram illustrating the structure of an exemplary broadcast system according to some implementations.

FIG. 3 is a block diagram illustrating the structure of an exemplary client device according to some implementations.

FIG. 4 is a flowchart illustrating an overview of the process of displaying information determined based on metadata contained in a video stream.

FIGS. 5A, 5B, 5C, 5D and 5E each include an exemplary screenshot according to some implementations.

FIGS. 6A and 6B are flowcharts illustrating the process of displaying information determined based on metadata contained in a video stream.

FIG. 7A is a flowchart illustrating the process of inserting metadata into a video stream.

FIG. 7B is a flowchart illustrating the process of determining a set of instructions based on metadata contained in a video stream.

Like reference numerals refer to corresponding parts throughout the drawings.

### DETAILED DESCRIPTION

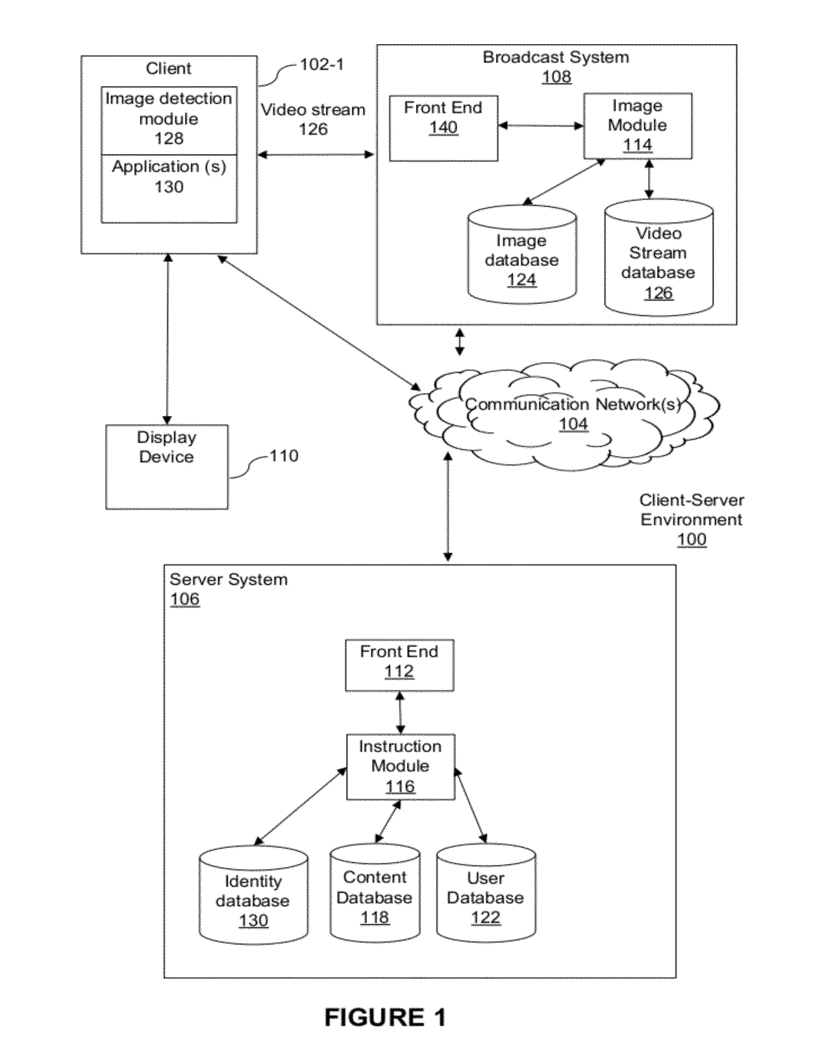

FIG. 1 is a block diagram illustrating a distributed system 100 that includes: one or more client devices 102, a communication network 104, a server system 106, a display device 110 and a broadcast system 108. The server system 106 is coupled to the one or more client devices 102 and the broadcast system 108 by the communication network 104. The broadcast system 108 inserts encoded images such as bar codes into video streams and broadcasts the video streams to one or more client devices 102. The server system 106 receives a request containing one or more strings e.g., strings of characters or symbols, decoded from an encoded image, determines a set of instructions based on the one or more strings and sends the set of instructions to a client device for execution. When executed by the client device, the set of instructions cause the client device to display information relating to the one or more strings decoded from the encoded image.

The functionality of the broadcast system 108 and the server system 106 can be combined into a single server system. In some implementations, the server systems 106 is implemented as a single server system, while in other implementations it is implemented as a distributed system of multiple servers. Solely for convenience of explanation, the server system 106 is described below as being implemented on a single server system. In some implementations, the broadcast system 108 is implemented as a single server system, while in other implementations it is implemented as a distributed system of multiple servers. Solely, for convenience of explanation, the broadcast system 108 is described below as being implemented on a single server system.

The communication network(s) 104 can be any wired or wireless local area network (LAN) and/or wide area network (WAN), such as an intranet, an extranet, or the Internet. It is sufficient that the communication network 104 provides communication capability between the one or more client devices 102 and the server system 106. In some implementations, the communication network 104 uses the HyperText Transport Protocol (HTTP) to transport information using the Transmission Control Protocol/Internet Protocol (TCP/IP). HTTP permits client devices 102 to access various resources available via the communication network 104. The various implementations, however, are not limited to the use of any particular protocol.

In some implementations, the server system 106 includes a front end server 112 that facilitates communication between the server system 106 and the network 104. In some implementations, the front end server 112 is configured to receive requests for a set of instructions. In some implementations, the front end server 112 is configured to send a set of instructions to a requesting client device 102. In some implementations, the front end 112 is configured to send content files and/or links to content files. In this context, the term “content file” means any content of any format including, but not limited to, a video file, an image file, a music file, a web page, an email message, an SMS message, a content feed, an advertisement, a coupon, a playlist and an XML document. In some implementations, the front end server 112 is configured to send or receive one or more video streams.

In some implementations, the server system 106 includes a user database 122 that stores user data. In some implementations, the user database 122 is a distributed database.

In some implementations, the server system 106 includes a content database 118. In some implementations, the content database 118 includes videos, images, music, web pages, email messages, SMS messages, content feeds, advertisements, coupons, playlists, XML documents and any combination thereof. In some implementations, the content database 118 includes links to videos, images, music, web pages, email messages, SMS messages, content feeds, advertisements, coupons, playlists, XML documents and any combination thereof. In some implementations, the content database 118 is a distributed database.

A content feed (or channel) is a resource or service that provides a list of content items that are present, recently added, or recently updated at a feed source. A content item in a content feed may include metadata such as the content associated with the item itself (the actual content that the content item specifies), a title (sometimes called a headline), and/or a description of the content, a network location or locator (e.g., URL) of the content, or any combination thereof. For example, if the content item identifies a text article, the content item may include the article itself inline, along with the title (or headline), and locator. Alternatively, a content item may include the title, description and locator, but not the article content. Thus, some content items may include the content associated with those items, while others contain links to the associated content but not the full content of the items. A content item may also include additional metadata that provides additional information about the content. The full version of the content may be any machine-readable data, including but not limited to web pages, images, digital audio, digital video, Portable Document Format (PDF) documents, and so forth.

In some implementations, the server system 106 includes an instruction module 116 that manages and retrieves information stored in the content database 118 and the user database 122. As discussed in greater detail herein, the instruction module 116 generates a set of instructions based on information contained in a request received from a client 102 and/or information for a respective user stored in the user database 122. The instruction module 116 sends the one or more content files and/or the one or more links to content files to the front end server 112 for transmission to the requesting client 102.

In some implementations, the server system 106 includes an identity database 130 that stores one or more relevant identities and associated metrics. As discussed in more detail herein, an identity can be a person, place or thing and the associated metrics measure the importance of the respective identity. In some implementations, the identity database 130 is a distributed database.

In some implementations, the broadcast system 108 includes a front end server 140 that facilitates communication between the broadcast system 106, the client devices 102 and the server system 106. In some implementations, the front end server 140 is configured to send or receive one or more video streams. In some implementations, the front end server 140 is configured to transmit video streams over cable lines. In some implementations, the front end server 140 is configured to transmit video streams over the air using radio transmissions or satellite transmissions. In some implementations, the front end server 140 is configured to transmit video streams over the communication network 104.

In some implementations, the broadcast system 108 includes an image database 124 that stores encoded images. In some implementations, the encoded images are bar codes, bar codes, matrix barcodes, high contrast images or any combination thereof. In some implementations, the image database 120 is a distributed database.

A bar code is an optical machine-readable representation of data, which shows data about the object to which it attaches. Bar codes consist of bars, rectangles, dots, hexagons and other geometric patterns. For example, a bar code can be a quick responsive (QR) code, a matrix barcode or two-dimensional bar code, and a linear barcode. The arrangement of the bars, rectangles, dots, hexagons encodes data such as text, numbers, symbols and any combination thereof. For example, a bar code can encode a URL, text or phone number. As used herein, an encoded image is a bar code.

In some implementations, the broadcast system 108 includes a video stream database 126 that stores video streams. As discussed in greater detail herein, in some implementations, the video streams include encoded images. In some implementations, the video stream database 126 is a distributed database.

In some implementations, the broadcast system 108 includes an image module 114 that manages and retrieves information stored in the image database 124 and the video stream database 126. As discussed in more detail herein, the image module 114 inserts one or more encoded images from the image database 124 into video streams stored in the video stream database 126 to form modified video streams. In some implementations, a broadcaster or other digital communications/content provider, such as a cable, satellite, or internet content provider, inserts the one more images from the image database 124 into the video streams that they provide.

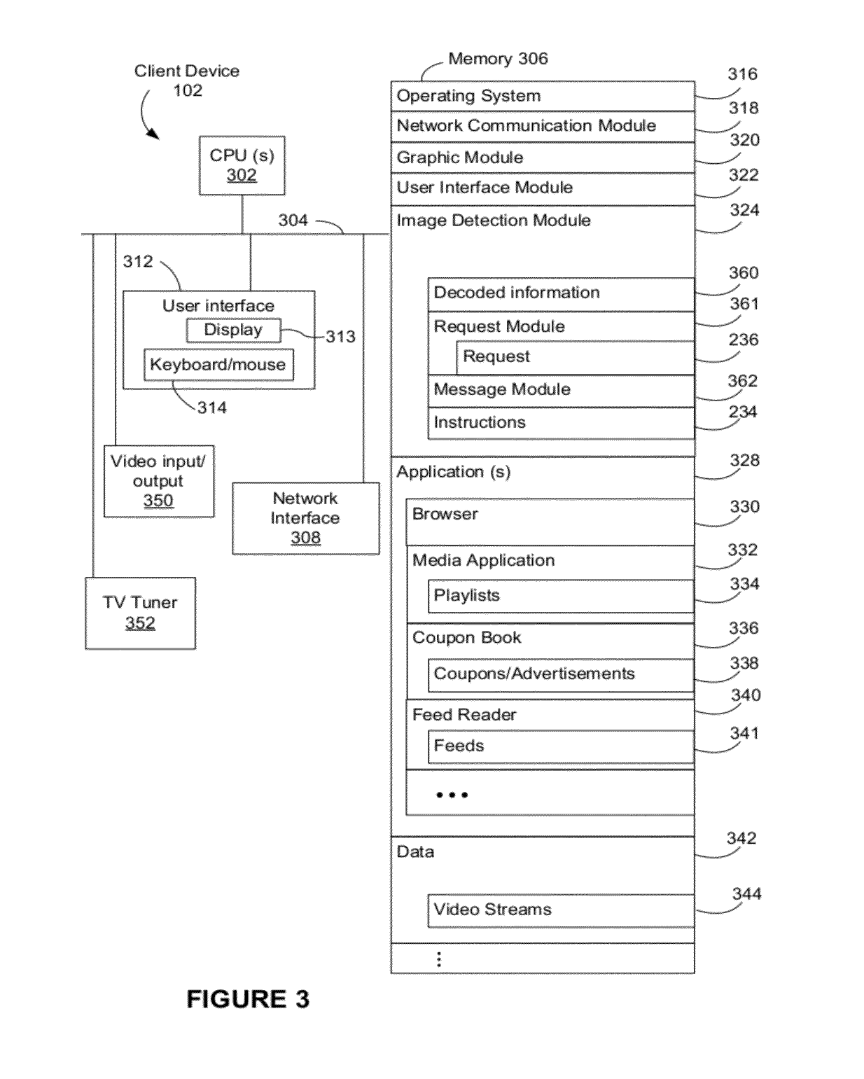

The client device 102 may be any suitable computer device that is capable of connecting to the communication network 104, such as a computer, such as a desktop computer, laptop computer, tablet device, netbook, internet kiosk, personal digital assistant, mobile phone, gaming device, or any other device that is capable of communicating with the server system 106. The client device 102 typically includes one or more processors, non-volatile memory such as a hard disk drive or flash memory and a display. The client device 102 may also have input devices such as a keyboard and a mouse (as shown in FIG. 3). In some implementations, the client device 102 includes a touch screen displays and/or microphones for input. In some implementations, the client device 102 is connected to a display device 110. In some implementations, the client device 102 includes display devices 110. In some implementations, a respective client 102 and a respective display device 110 are contained in a single device. In some implementations, the display device 110 is a television or a screen, such as an LCD or LED display. In some implementations, the display device 110 is a device that includes a screen, but lacks a tuner, such as a monitor.

The client devices 102 receive video streams 126 from one or more broadcast systems 108. In some implementations, a respective client device 102 receives a video stream from a cable lines, a satellite receivers, a network connection or an over the air antenna.

In some implementations, a respective client device 102 includes an image detection module 128 and one or more applications 130. As discussed in greater detail herein, the image detection module 128 detects and decodes encoded images in video streams.

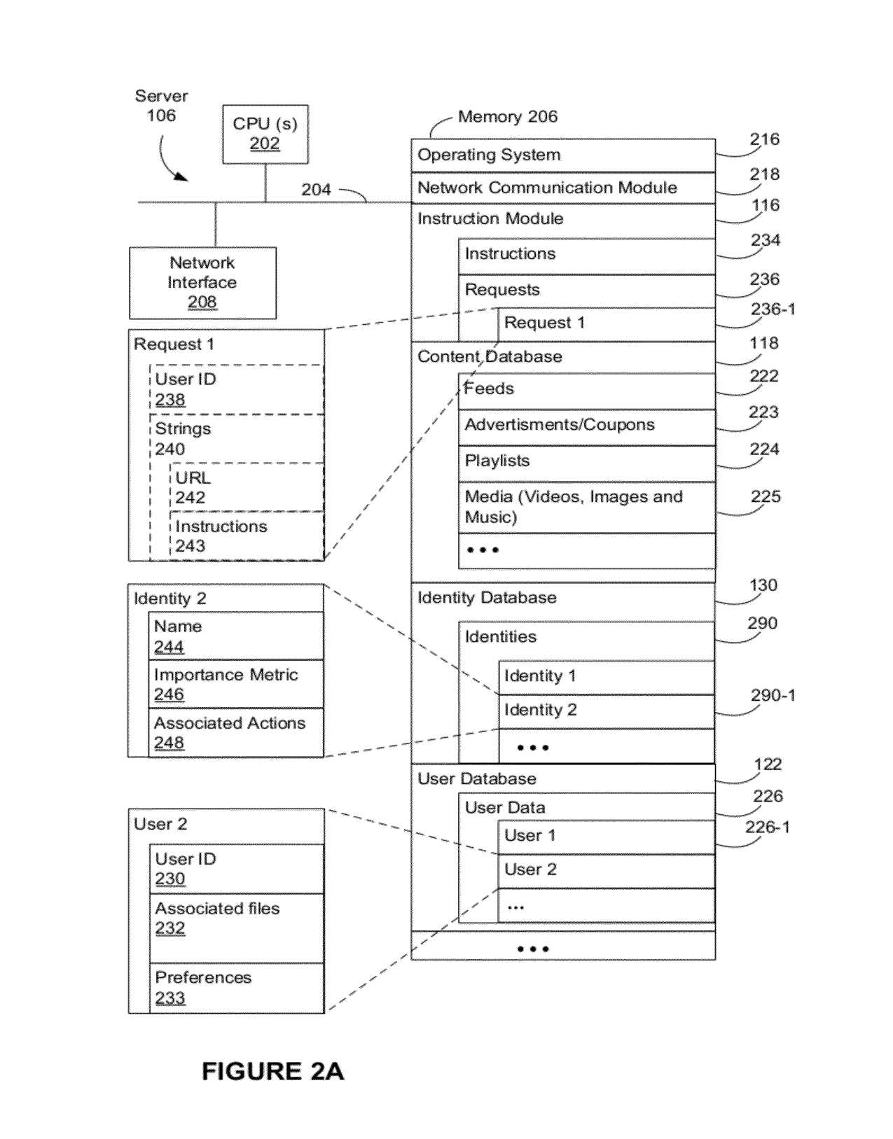

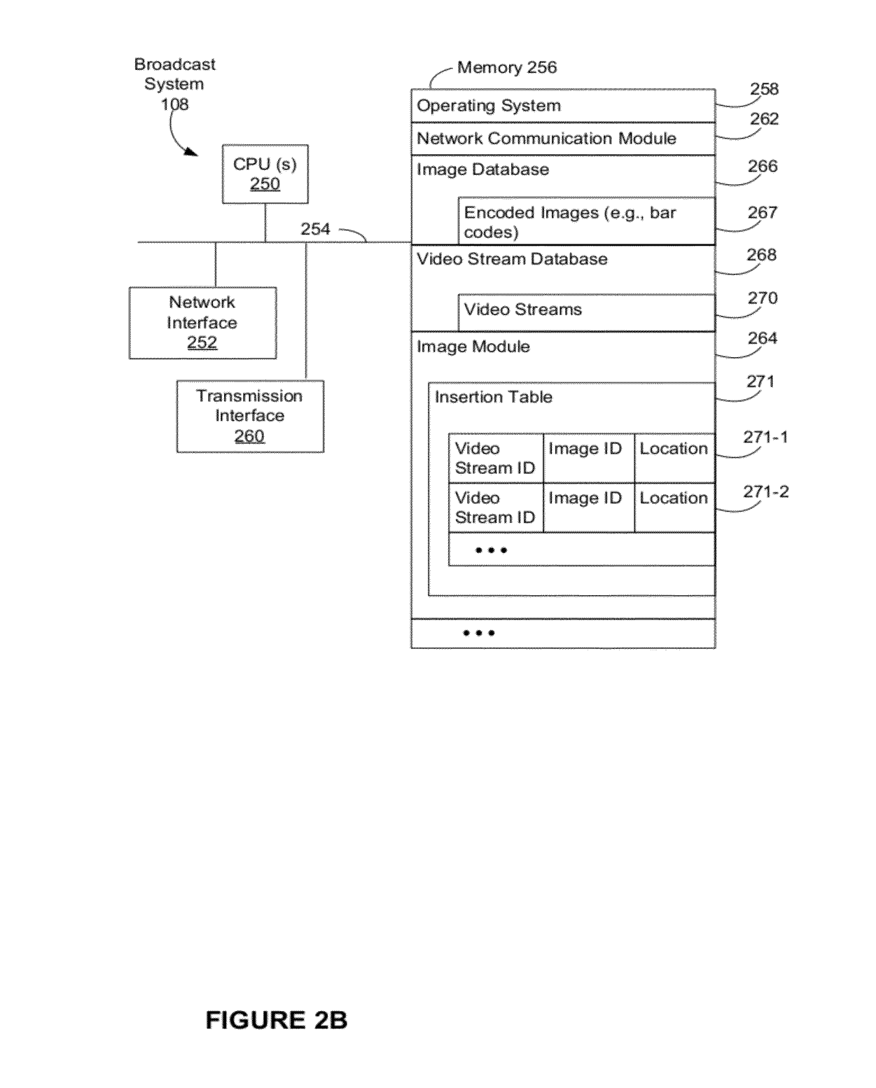

FIG. 2A is a block diagram illustrating a server system 106, in accordance with one implementation. The server system 106 typically includes one or more processing units (CPU's) 202, one or more network or other communications interfaces 208, memory 206, and one or more communication buses 204 for interconnecting these components. The communication buses 204 optionally include circuitry (sometimes called a chipset) that interconnects and controls communications between system components. Memory 206 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the CPU(s) 202. Memory 206, including the non-volatile and volatile memory device(s) within memory 206, comprises a non-transitory computer readable storage medium. In some implementations, memory 206 or the non-transitory computer readable storage medium of memory 206 store the following programs, modules and data structures, or a subset thereof including an operation system 216, a network communication module 218, a instruction module 116, a content database 118 and a user database 122.

The operating system 216 includes procedures for handling various basic system services and for performing hardware dependent tasks.

The network communication module 218 facilitates communication with other devices via the one or more communication network interfaces 208 (wired or wireless) and one or more communication networks, such as the Internet, other wide area networks, local area networks, metropolitan area networks, and so on.

The content database 118 includes content files and/or links to content files. In some implementations, the content database 118 stores videos, images, music, web pages, email messages, SMS messages, a content feeds, advertisements, coupons, playlists, XML documents and any combination thereof. In some implementations, the content database 118 includes links to videos, images, music, web pages, email messages, SMS messages, content feeds, advertisements, coupons, playlists, XML files and any combination thereof. In some implementations, each content file in the content database 118 has an associated metric. In some implementations, the metric measures the popularity or importance of the content file. In some implementations, each content file in the content database 118 has an associated timestamps that specify the time the content file was created and the time the content file was last updated. In some implementations, each content file in the content database 118 has an associated category. For example, a music file may have the category of “classical,” a coupon may have the category of advertisement and a feed may have the category of “sports.”

The user database 122 includes user data 226 for one or more users. In some implementations, the user data for a respective user 226-1 includes a user identifier 230 and associated files 232. In some implementations, user data for a respective user 226-1 includes preferences 233. The user identifier 230 identifies a user. For example, the user identifier 230 can be an IP address associated with a client device 102 or an alphanumeric value chosen by the user or assigned by the server that uniquely identifies the user. In some implementations, the associated files 232 include a list of identifiers of files stored in the content database 118 that are associated with the user. For example, files associated with a user can include music files, content feeds, coupons and playlists. In some implementations, the preferences 233 include categories of information the user is or is not interested in. For example, a user may have no interest in sports and an interest in science fiction. In some implementations, the preferences 233 include counts or score for categories for interest. For example, each category may include a number representing a number of times a user has viewed an item associated with the category. In some implementations, the score for a respective category represents a user's affinity towards the respective category. In some implementations the counts or scores are based on the number of times a user has viewed an item associated with an encoded image.

The identity database 130 stores one or more identities 290. A respective identity 290-1 includes a name 244, an importance metric 246 and associated actions 248. The name 244 identifies the identity. For example, the name 244 could be the name of a person, place or thing. For example, an identity could be an actor, a product, a country or a company. The importance metric 246 measures the importance of the identity and is used to determine which identity among a set of identities is most important. The associated actions 248 specify one or more actions to take if the corresponding identity is chosen. For example, the associated action for a country identity may be to show a webpage containing information about the country. The identity of a celebrity may be associated with various actions such as showing recent content items, showing a web page, adding songs to a user's playlist or sending the user coupons for an event involving the person.

The instruction module 116 generates instructions 234. The instruction module 116 uses the strings 240 contained in a request 236-1 to identify one or more relevant identities 290 in the identity database 130 and generates a set of instructions 234 based on the one or more identified relevant identities 290.

In some implementations the instruction module 116 generates instructions 234 in response to receiving a request 236. In some implementations, a request 236-1 includes a user identifier 238 and strings 240. The user identifier 238 identifies a user. In some implementations, the strings 240 include information decoded from images displayed in video streams that contain encoded information. When a video stream is displayed at a client device 102, the client device 102 detects encoded images, decodes the images and sends one or more requests 236 containing the decoded information to the server system 106. In some implementations, the strings 240 include a URL 242. In some implementations, the strings 240 include text consisting of alphabet characters and/or numbers. In some implementations, the strings 240 include the name of a person, place or thing and a name of an application. In some implementations, the strings 240 include the name of a video stream or the category of the video stream. For example, the strings 240 may include the name of a movie and the category or genre of the movie (e.g., drama, science fiction etc.). In some implementations, the strings 240 include a set of instructions 234. In some implementations, the set of instructions 234 include instructions to invoke one or more applications. In some implementations, the set of instruction 234 include instructions to display and/or send one or more messages. In some implementations, the messages include email messages and SMS messages.

In some implementations, a set of instructions 234 is included in a request 236 and the instruction module 116 parses the request 236 to obtain the set of instructions 234. Stated in another way, in some implementations, the instructions module 116 parses the strings 240 to obtain the set of instructions 234. In some implementations, the instruction module 116 generates the set of instructions 234 based on information contained in a request 236. In some implementations, the instruction module 116 generates a set of instructions 234 based on the user identifier 238 and/or strings 240 contained in a request 236. In some implementations, when a URL is contained in the strings 240, the URL identifies a document containing a set of instructions 234. In some implementations, the instruction module 116 generates a set of instructions 234 based on the strings 240 contained in a request 236. In some implementations, the set of instructions 234 are included in the strings 240.

In some implementations, the instruction module 116 uses the strings 240 contained in a request 236 to generate search queries to identify relevant identities 290 in the identity database 118. For example, the instruction module 116 may construct a query for each string in the strings 240. In some implementations, the instruction module 116 filters the identified relevant identities based on the importance metric 246 associated with the respective identities. For example, the instruction module 116 may select only identities that have an importance metric 242 above a predefined threshold or may select only the top few identities among a set of identities. As discussed above, each identity 290 includes an associated action 248. Once the relevant identities are selected, the instructions module 116, generates the set of instruction 234 based on the associated actions 248 for the one or more selected relevant identities.

In some implementations, the instruction module 116 uses the selected relevant identities to generate search queries to identify one or more content files in the content database 118. The instruction module 116 selects one or more of the identified content files based on predefined criteria. In some implementations, the predefined selecting content files based on popularity. For example, the most or least popular content files may be selected. In some implementations, the content files are selected based on what is recently popular. For example, recently popular content files have a large increase in popularity in a recent time period. In some implementations, the most relevant content file is selected. In some implementations, the most recently updated or created content files are selected.

In some implementations, the set of instructions 234 includes instructions to invoke one or more functions or applications on a client device 102. The applications can be any application on the client device 102. In some implementations, the one or more applications are selected from the group consisting of a media application, a feed reader application, a browser application and a coupon book application. In some implementations, the one or more applications are selected based on the type document identified using the selected relevant identities as search queries. For example, if a music file is identified then a media application is selected. In some implementations, the set of instructions 234 includes instructions to invoke an application and instructions to direct the invoked application to download one or more documents contained in the content database 118. For example, the instruction module 116 may generate instructions to invoke a feed reader application and instructions to cause the feed reader application to download content items. In another example, the instruction module 116 may generate instructions to invoke a web browser and instructions to cause the web browser to connect to a particular website (e.g., a product website).

In some implementations, the set of instructions 234 include instructions to display a message on the display of the client device 102. In some implementations, the user data 226 for the user identified by the user identifier 238 includes the user's telephone number and/or email address. In some implementations, set of instructions 234 includes instructions to send an email message or SMS message to the user identified by the user identifier 238. For example, the message may contain a promotional offer relating to the video segment.

In some implementations, the instruction module 116 determines the set of instructions 234 based in part on associated files 232 and/or preferences 233 stored for a respective user in the user database 122. For example, the instruction module 116 may check if a user has a song associated with the user's account before generating instructions to add the song to the user's playlist. The preferences 233 associated with the user indicate categories of information the user likes or dislikes. The instruction module 116 determines a set of instruction 234 that causes a client 102 to display information associated with a category of information that a respective user is interested in. For example, the user may like sports and the instruction module 116 may generate a set of instructions 234 to add sports related content to the user's feed reader application.

After generating the set of instructions 234, the instruction module 116 sends the set of instructions 234 to the requesting client device 102. In some implementations, the instructions 234 generated by the instruction module 118 are contained in a content feed. In some implementations, the instructions module 116 retrieves and sends one or more content files and/or content file links (stored n the content database 118) with the set of instructions 234.

Each of the above identified elements may be stored in one or more of the previously mentioned memory devices, and each of the modules or programs corresponds to a set of instructions for performing a function described above. The set of instructions can be executed by one or more processors (e.g., the CPUs 202). The above identified modules or programs (i.e., sets of instructions) need not be implemented as separate software programs, procedures or modules, and thus various subsets of these modules may be combined or otherwise re-arranged in various implementations. In some implementations, memory 206 may store a subset of the modules and data structures identified above. Furthermore, memory 206 may store additional modules and data structures not described above.

Although FIG. 2A shows a server system, FIG. 2A is intended more as functional description of the various features which may be present in a set of servers than as a structural schematic of the implementations described herein. In practice, and as recognized by those of ordinary skill in the art, items shown separately could be combined and some items could be separated. For example, some items (e.g., operating system 216 and network communication module 218) shown separately in FIG. 2A could be implemented on single servers and single items could be implemented by one or more servers. The actual number of servers used to implement the server system 106 and how features are allocated among them will vary from one implementation to another, and may depend in part on the amount of data traffic that the system must handle during peak usage periods as well as during average usage periods.

FIG. 2B is a block diagram illustrating a broadcast system 108, in accordance with one implementation. The broadcast system 108 typically includes one or more processing units (CPU's) 250, one or more network or other communications interfaces 252, memory 256, a transmission interface 260 and one or more communication buses 204 for interconnecting these components. The communication buses 252 optionally include circuitry (sometimes called a chipset) that interconnects and controls communications between system components. Memory 256 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 256 may optionally include one or more storage devices remotely located from the CPU(s) 250. Memory 256, including the non-volatile and volatile memory device(s) within memory 256, comprises a computer readable storage medium. In some implementations, memory 256 or the non-transitory computer readable storage medium of memory 256 store the following programs, modules and data structures, or a subset thereof including an operation system 258, a network communication module 262, a image module 264, a image database 266 and a video stream database 268.

The transmission interface 260 transmits video streams via radio transmissions, satellite transmissions or through cable lines.

The operating system 258 includes procedures for handling various basic system services and for performing hardware dependent tasks.

The network communication module 252 facilitates communication with other devices via the one or more communication network interfaces 208 (wired or wireless) and one or more communication networks, such as the Internet, other wide area networks, local area networks, metropolitan area networks, and so on. In some implementations, the network communication module 262 transfers video streams stored in the video stream database 268 via the network interface 252.

The image database 124 stores encoded images 267. In some implementations, the images are bar codes, bar codes, matrix barcodes, high contrast images or any combination thereof.

The video stream database 268 stores video streams 270. In some implementations, the video streams include encoded images such as bar codes, bar codes, matrix barcodes or high contrast images.

The image module 264 generates images containing encoded information. In some implementations, the generated images are bar codes, bar codes, matrix barcodes, high contrast images or any combination thereof. In some implementations, the information encoded in the generated images corresponds to a URL, text string or an alphanumeric string. As discussed above, high contrast images such as bar codes include black bars arranged into patterns to encode information. In some implementations, the image module 264 generates encoded images in response to a request. The image module 264 stores the generated images in the image database 266. As discussed in more detail herein, content providers may add metadata to video streams by inserting images containing encoded information into the video streams.

In some implementations, the image module 264 includes an insertion table 271. The insertion table 271 includes information matching encoded images 267 from the image database 266 to video streams 270 in the video stream database 268. Each row of the insertion table 271 includes a video stream identifier, an image identifier and a location. The video stream identifier identifies a video stream 270 in the video stream database 268. The image identifier identifies an encoded image 267 in the image database 266. The location identifies where and when in the video stream 270 that the encoded image 267 should be inserted into. The location information includes a timestamp or a frame number to indicate where in the video stream 270 the encoded image 267 should be inserted. The location information also includes display position information to indicate where in the video stream the encoded image 267 should be inserted. For example, the display position information may be represented by coordinate values. The location may be represented by a timestamp or a frame number. The frame number identifies a frame in a respective video stream. The information in the insertion table 271 is provided by broadcasters and/or content providers. Broadcasters and content providers determine what images are inserted into a video stream and where the images are inserted.

In some implementations, the image module 264 inserts an image with encoded information (e.g., a bar code) at a particular display position in a predefined number of frames of a video stream. An encoded image's display position refers to the position the image is displayed at when the corresponding video frame is displayed. For example, a display position may be represented by coordinate values (e.g., pixel coordinates). It is noted that the encoded image is placed at the same display position for a consecutive number of frames. For example, the image module 264 may insert a bar code into the bottom right corner of 40 consecutive frames of a video stream. It is noted that the larger number of consecutive frames that the encoded image is inserted into, the longer the encoded image is displayed when the corresponding video stream is displayed. The encoded image is included in a predefined number of consecutive frames in order to allow a module (e.g., image detection module 324) on the client device 102 to detect the encoded image. To determine which image or images to insert into a video stream, the image module 264 searches the insertion table 271 for entries corresponding to the video stream. For a respective video stream 270, the image module 264 identifies one or more entries in the insertion table 271 corresponding to the respective video 270, retrieves, from the image database 266, one or more encoded images specified by the image ID fields of the one or more identified entries and inserts the one or more encoded images into the respective video stream 270 at the respective locations specified by the one or more identified entries. For example, a respective video stream 270 may have a single corresponding entry 271-1 in the insertion table 271 and the image module 264 retrieves the encoded image specified by the image ID field of the entry 271-1 and inserts the encoded image in the respective video stream at the location specified by the location field of the entry 271-1.

In some implementations, the image module 264 retrieves a video stream 270 from the video stream database 268, inserts an encoded image into the video stream to form a modified stream and stores the modified video stream in the video stream database 268.

In some implementations, the functionality of broadcast system 108 and server system 106 can be combined on a single server system.

Each of the above identified elements may be stored in one or more of the previously mentioned memory devices, and each of the modules or programs corresponds to a set of instructions for performing a function described above. The set of instructions can be executed by one or more processors (e.g., the CPUs 250). The above identified modules or programs (i.e., sets of instructions) need not be implemented as separate software programs, procedures or modules, and thus various subsets of these modules may be combined or otherwise re-arranged in various implementations. In some implementations, memory 256 may store a subset of the modules and data structures identified above. Furthermore, memory 256 may store additional modules and data structures not described above.

Although FIG. 2B shows a broadcast system, FIG. 2B is intended more as functional description of the various features which may be present in a set of servers than as a structural schematic of the implementations described herein. In practice, and as recognized by those of ordinary skill in the art, items shown separately could be combined and some items could be separated. For example, some items (e.g., operating system 258 and network communication module 262) shown separately in FIG. 2B could be implemented on single servers and single items could be implemented by one or more servers. The actual number of servers used to implement the broadcast system 108 and how features are allocated among them will vary from one implementation to another, and may depend in part on the amount of data traffic that the system must handle during peak usage periods as well as during average usage periods.

FIG. 3 is a block diagram illustrating a client device 102, in accordance with some implementations. The client device 102 typically includes one or more processing units (CPU's) 302, one or more network or other communications interfaces 308, memory 306, and one or more communication buses 304, for interconnecting these components. The communication buses 304 optionally include circuitry (sometimes called a chipset) that interconnects and controls communications between system components. The client device 102 may also include a user interface comprising a display device 313 and a keyboard and/or mouse (or other pointing device) 314. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302. Memory 306, or alternatively the non-volatile memory device(s) within memory 306, comprises a computer readable storage medium. In some implementations, client device 102 is a portable electronic device with a touch screen display. In some implementations, memory 306 or the computer readable storage medium of memory 306 store the following programs, modules and data structures, or a subset thereof including operation system 316, network communication module 318, graphics module 320, user interface module 322, image detection module 324, applications 328 and data 342.

The client device includes a video input/output 350 for receiving and outputting video streams. In some implementations, the video input/output 350 is configured to receive video streams from radio transmissions, satellite transmissions and cable lines. In some implementations the video input/output 350 is connected to a cable box. In some implementations, the video input/output 350 is connected to a satellite dish. In some implementations, the video input/output 350 is connected to an antenna.

In some implementations, the client device includes a television tuner 352 for receiving and recording video streams.

The operating system 316 includes procedures for handling various basic system services and for performing hardware dependent tasks.

The network communication module 318 facilitates communication with other devices via the one or more communication network interfaces 304 (wired or wireless) and one or more communication networks, such as the Internet, other wide area networks, local area networks, metropolitan area networks, and so on.

The user interface module 322 tracks user input and selections to the client device 102.

The graphic module 320 displays the user interfaces associated with the applications 328.

The data 342 includes video streams 344. In some implementations, the video streams 344 include encoded images.

In some implementations, the applications 328 include a browser 330, a media application 332, a coupon book application 336 and a feed reader application 340. The browser 330 provides a display of web pages that a user can see. The media application 332 plays videos, music, displays images and manages playlists 334. The feed reader application 340 displays content feeds 341. The coupon book application 336 stores coupons/advertisements 338. In some implementations, the applications 328 include one or more gaming applications. The applications 328 are not limited to the applications discussed above.

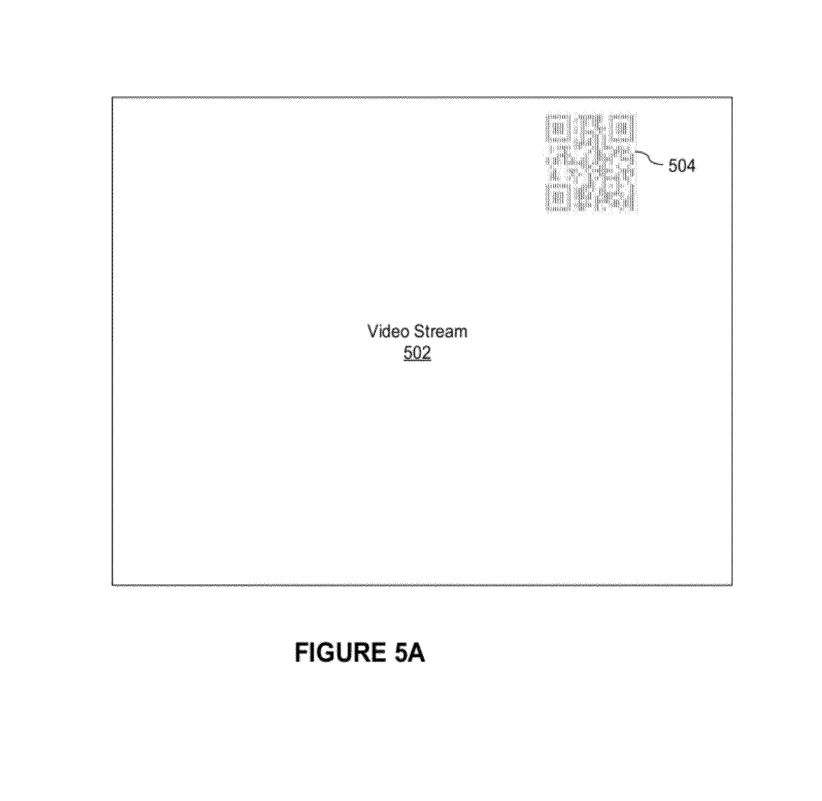

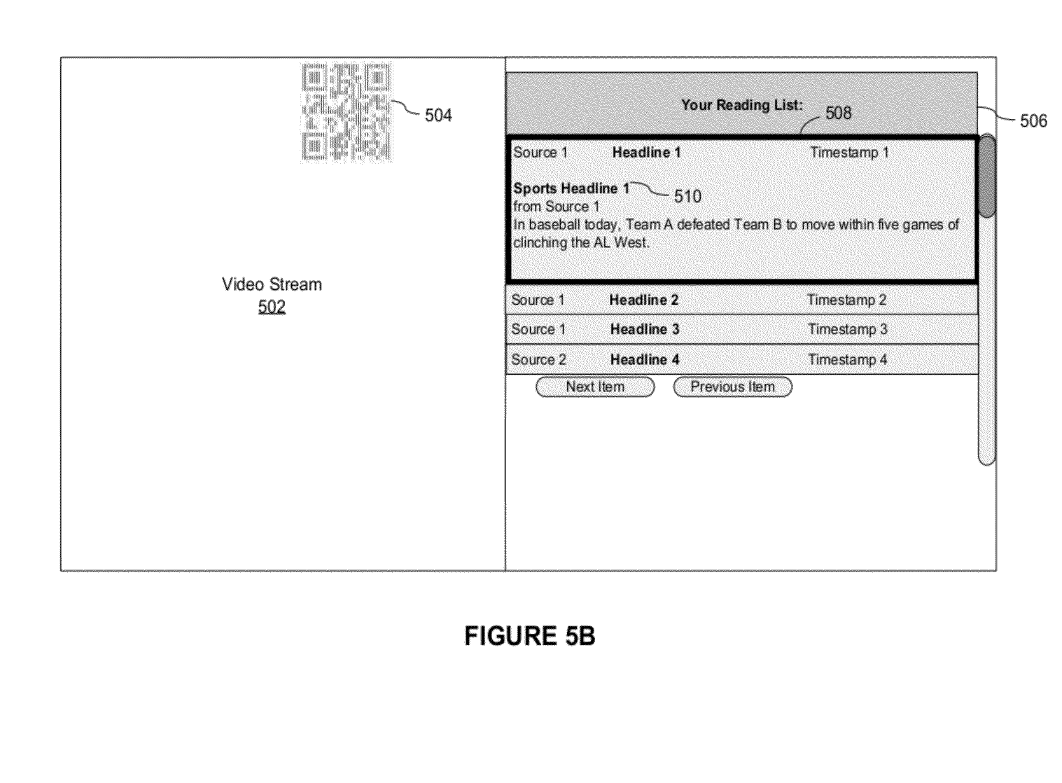

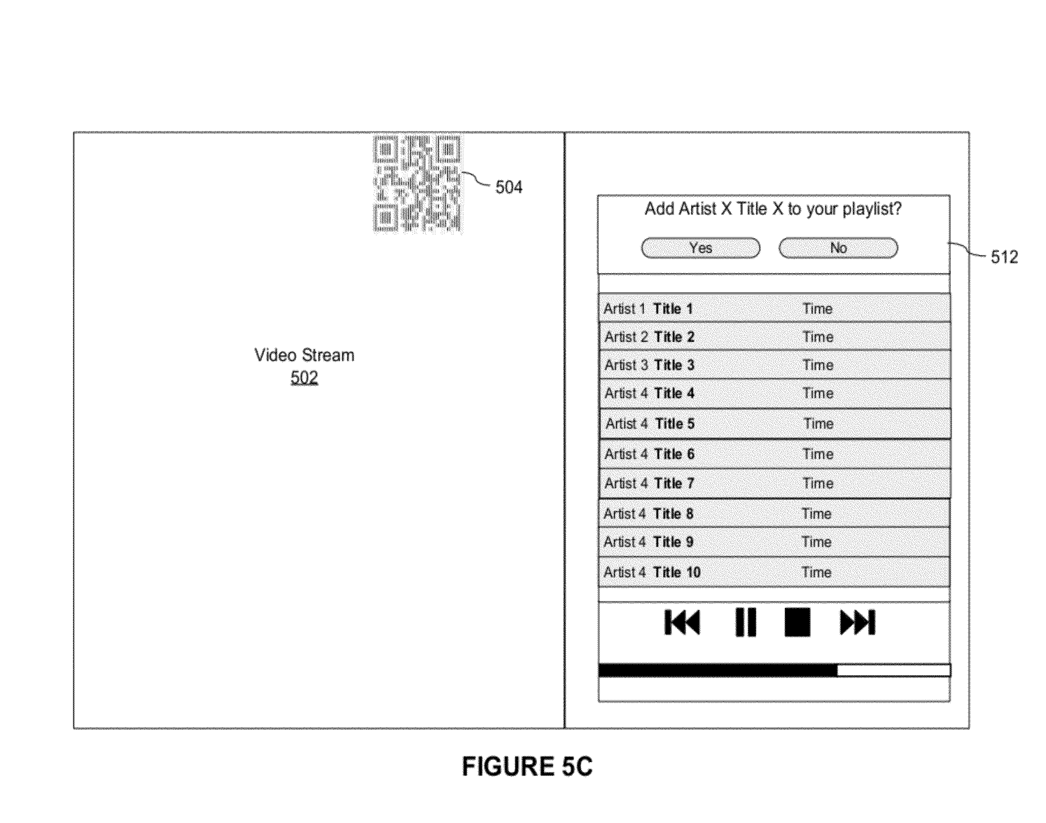

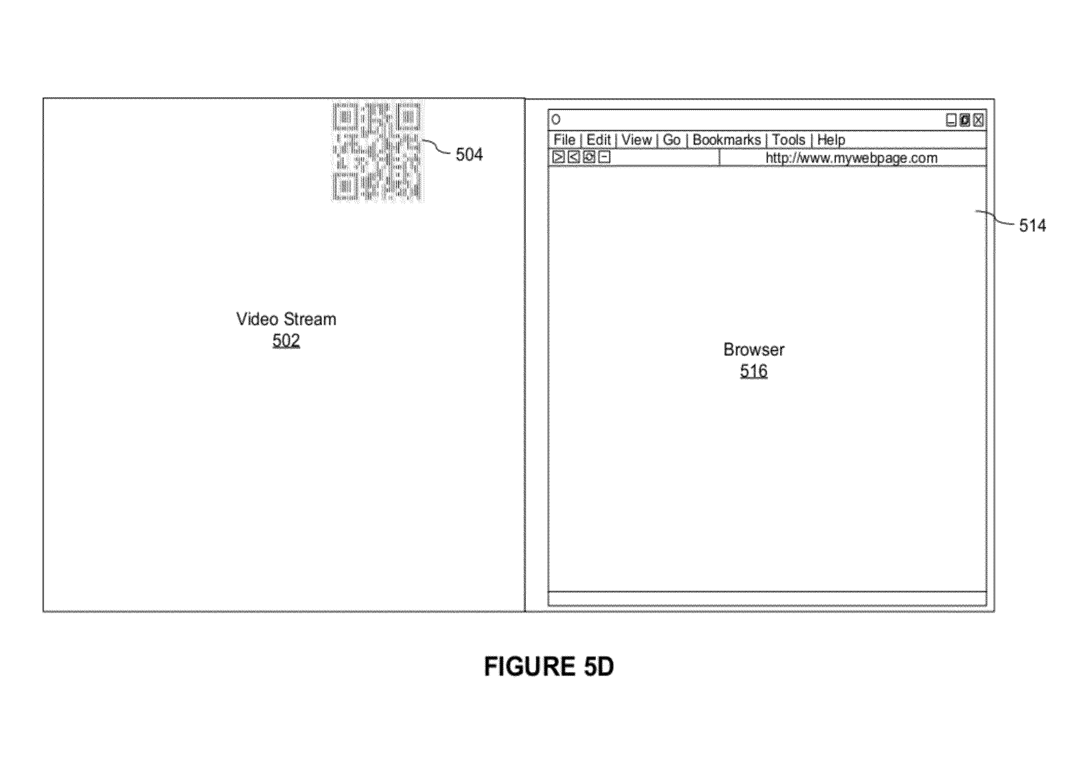

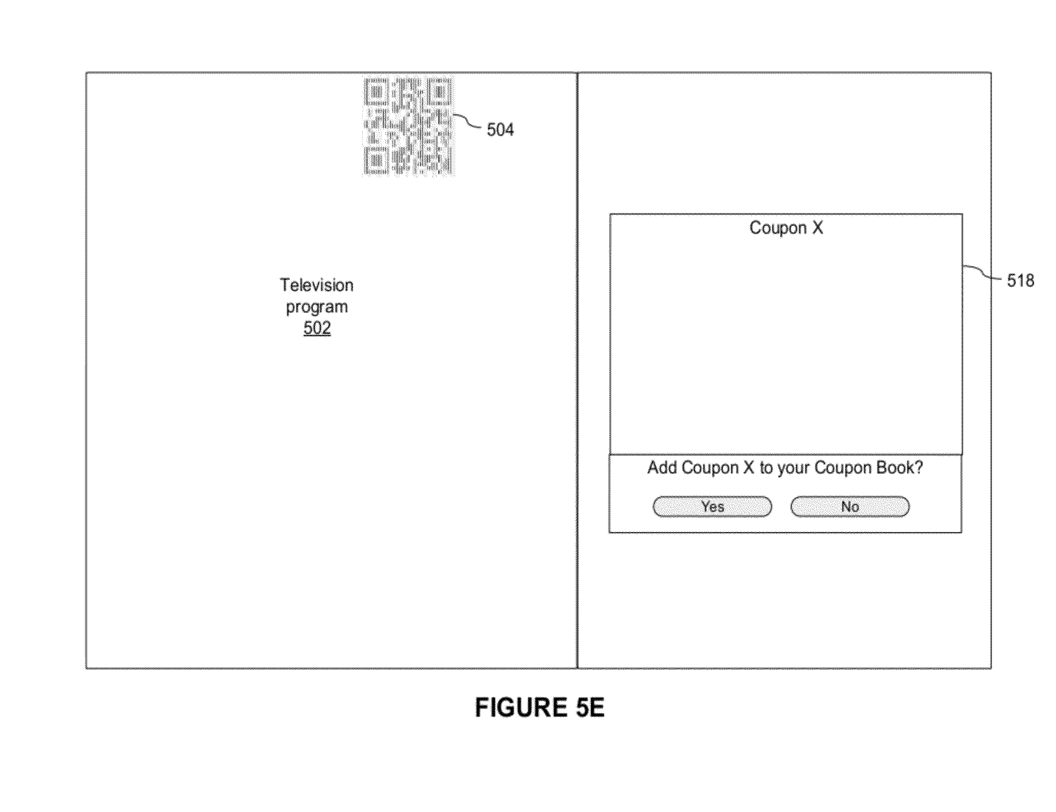

The image detection module 324 detects encoded images in video streams. In some implementations, the encoded images are bar codes, bar codes, matrix barcodes or high contrast images. In some implementations, the detecting includes determining that an encoded image is displayed at a particular display position in a predefined number of consecutive frames of a video stream. For example, as shown in the FIG. 5A, a bar code 502 may be displayed at the upper right corner of the screen for a predefined number of consecutive frames. Stated in another way, the image detection module 324 detects images that are displayed at the same location in a consecutive number of frames. In some implementations, the image detection module 324 detects encoded images within a respective video stream 344 while the video stream is playing or being displayed on a display (e.g., 313 or 110). In some implementations, the image detection module 324 detects particular images within a respective video stream 344 stored on the client device 102. The encoded image may have been inserted into the video stream by a broadcaster or content provider desiring to provide a user with information relating to the video stream.

After the encoded image is detected, the image detection module 324 decodes the image to obtain decoded information 360. For example, if the image is a bar code, the image is decoded using well known techniques to obtain a text string. In some implementations, the decoded information 360 comprises a URL. In some implementations, the decoded information 360 comprises one or more strings.

In some implementations, the decoded information 360 from the detected image is sent to the server 106 in a request 236 generated by a request module 361. In some implementations, the request 236 includes a user identifier 238 associated with a user of the client 102. In some implementations, when the decoded information 360 from the detected image is a URL, the image detection module 324 accesses the URL to obtain a document containing instructions. In some implementations, the URL identifies a content feed of instructions.

In response to sending the request 236 or accessing a URL, the image detection module 324 receives a set of instructions 234. In some implementations, the set of instructions 234 are contained in a content feed.

The image detection module 324 executes the set of instructions 234 in response to receiving the one or more instructions. In some implementations, the set of instructions 234 includes instructions to display a message on the display (e.g., 313 and 110). For example, the message may offer a user a product or service relating to a video stream. In some implementations, the message is displayed by the message module 362. In some implementations, the set of instructions 234 includes instructions to send an email message or SMS message to a user. For example, the email message or SMS message may include a coupon or promotional offer. In some implementations, the email message or SMS message is sent by the message module 362.

In some implementations, the set of instructions 234 includes instructions to execute one or more applications 328. Examples of the applications are discussed in greater detail in the discussion of FIGS. 5B, 5C, 5D and 5E. The one or more applications can be any type of application and are not limited to those shown in FIGS. 5B, 5C, 5D and 5E. The image detection module 324 executes the set of instructions 234 received from the server.

Each of the above identified elements may be stored in one or more of the previously mentioned memory devices, and each of the modules or programs corresponds to a set of instructions for performing a function described above. The set of instructions can be executed by one or more processors (e.g., the CPUs 302). The above identified modules or programs (i.e., sets of instructions) need not be implemented as separate software programs, procedures or modules, and thus various subsets of these modules may be combined or otherwise re-arranged in various implementations. In some implementations, memory 306 may store a subset of the modules and data structures identified above. Furthermore, memory 306 may store additional modules and data structures not described above.

Although FIG. 3 shows a client device, FIG. 3 is intended more as functional description of the various features which may be present in a client device than as a structural schematic of the implementations described herein. In practice, and as recognized by those of ordinary skill in the art, items shown separately could be combined and some items could be separated.

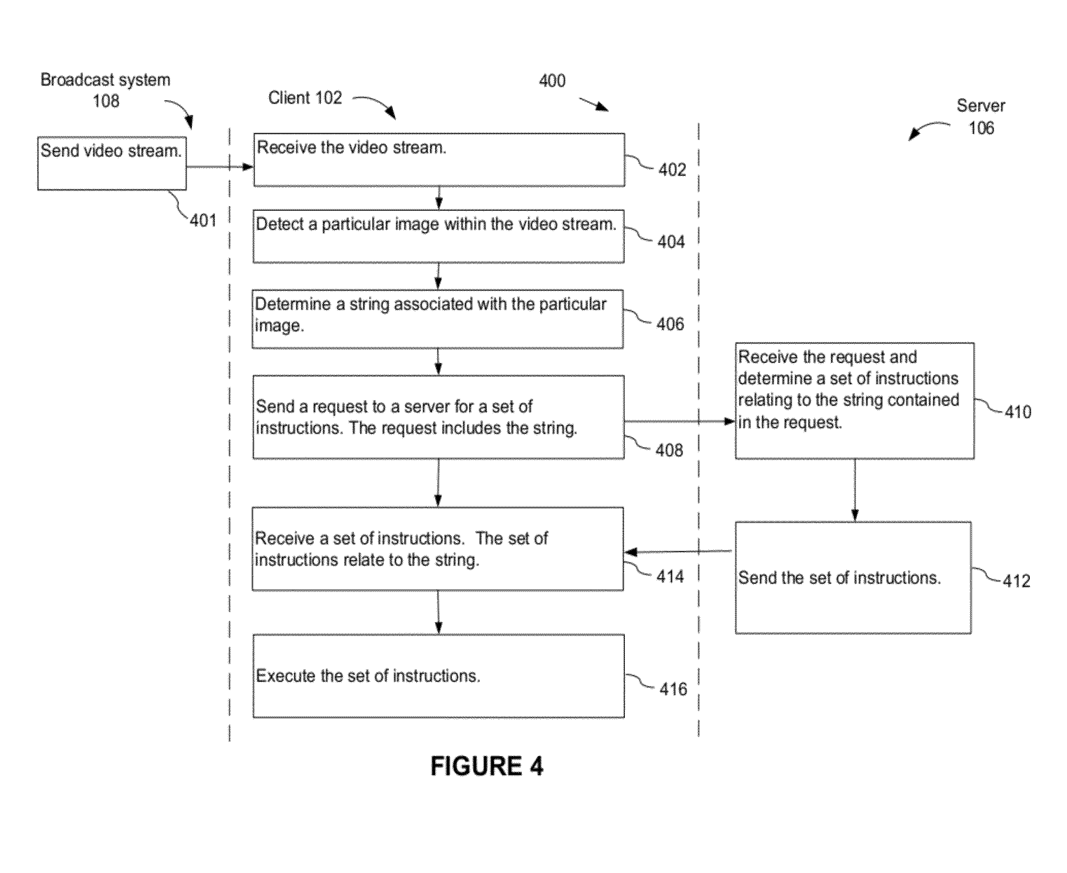

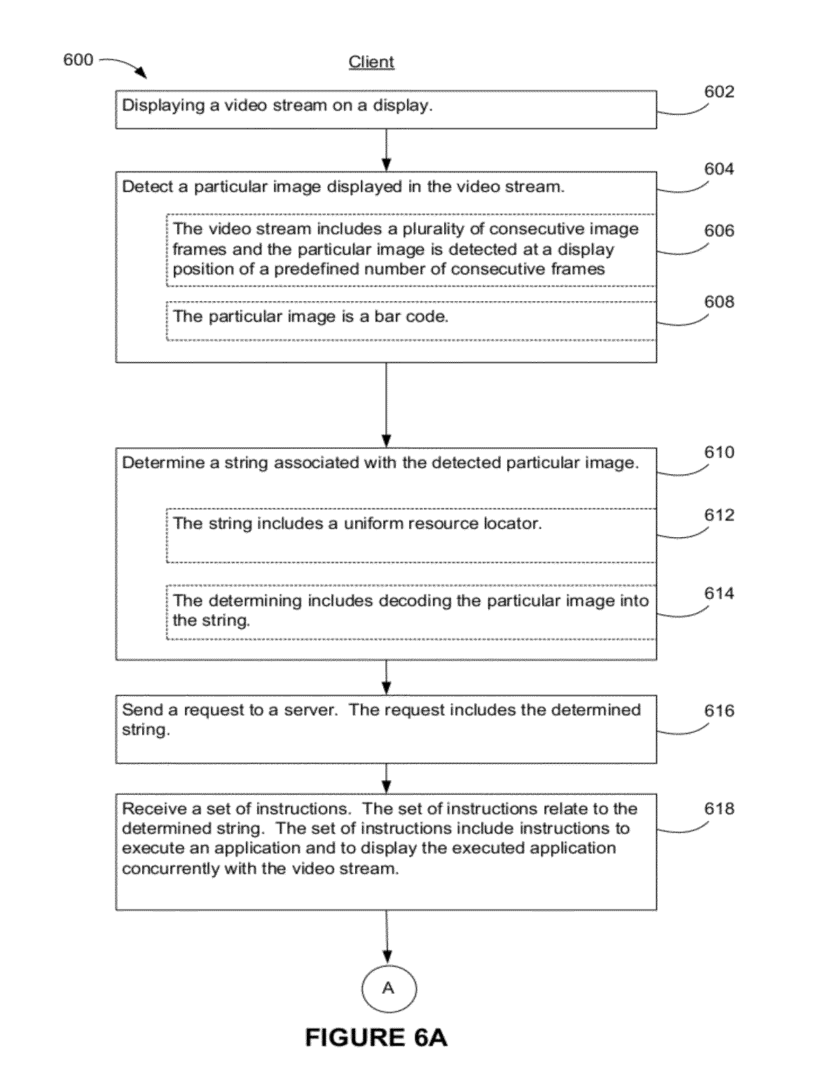

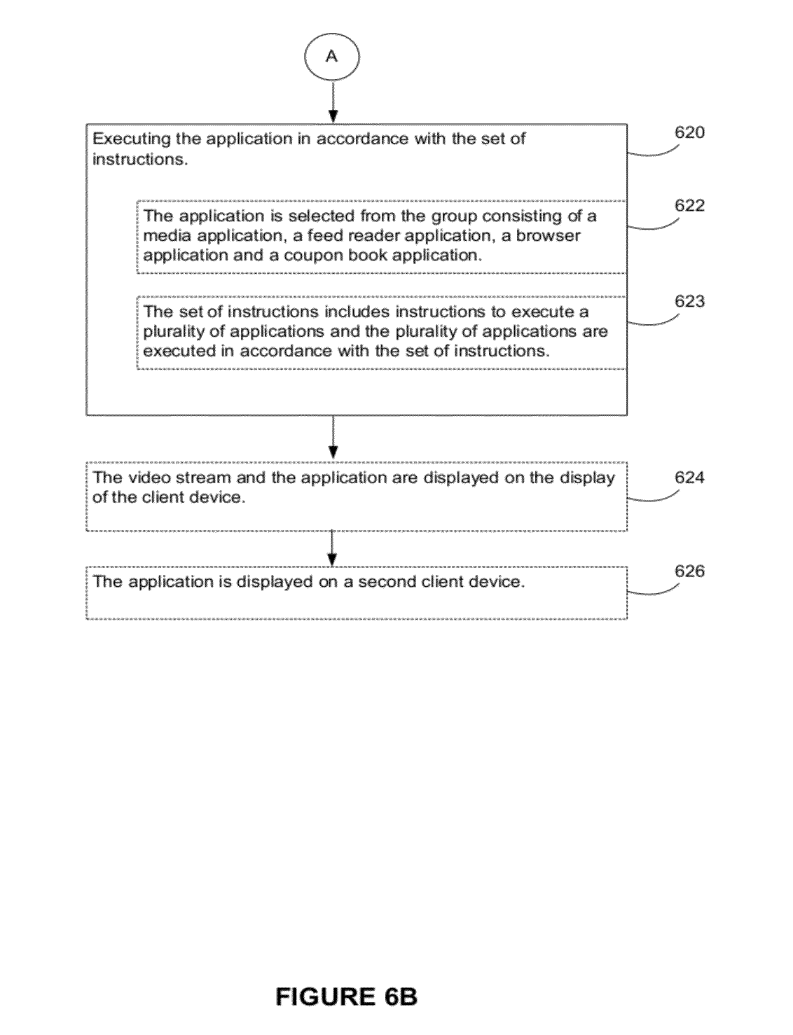

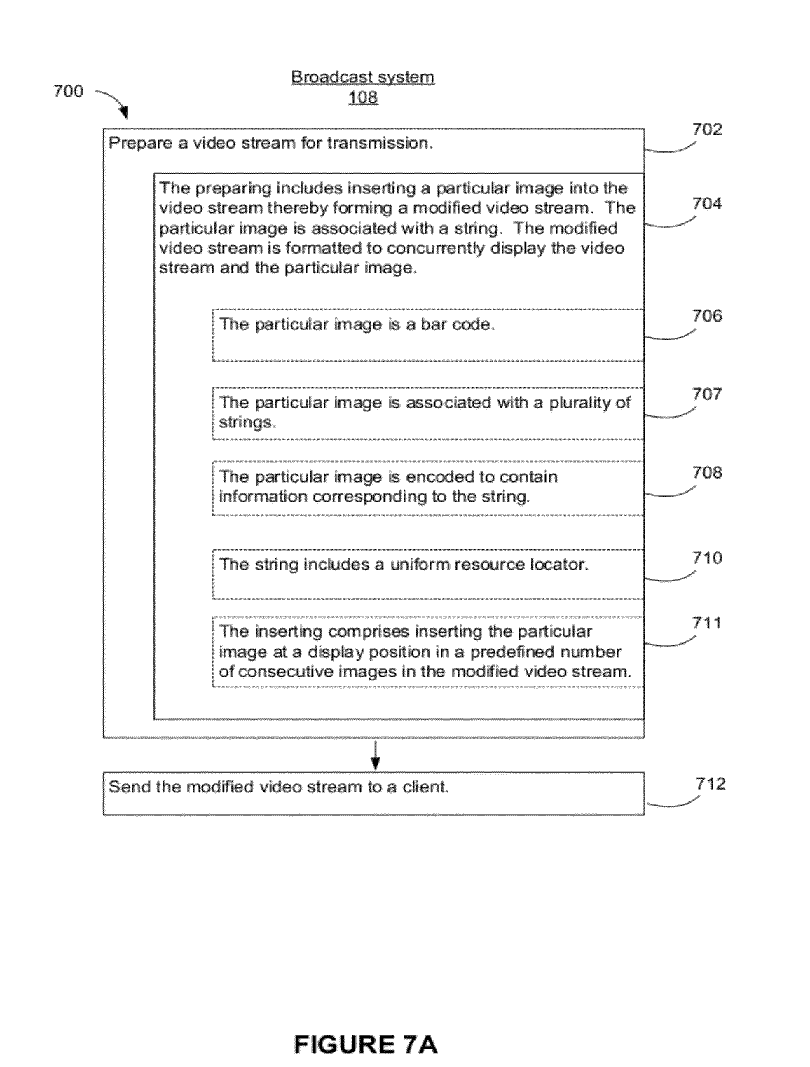

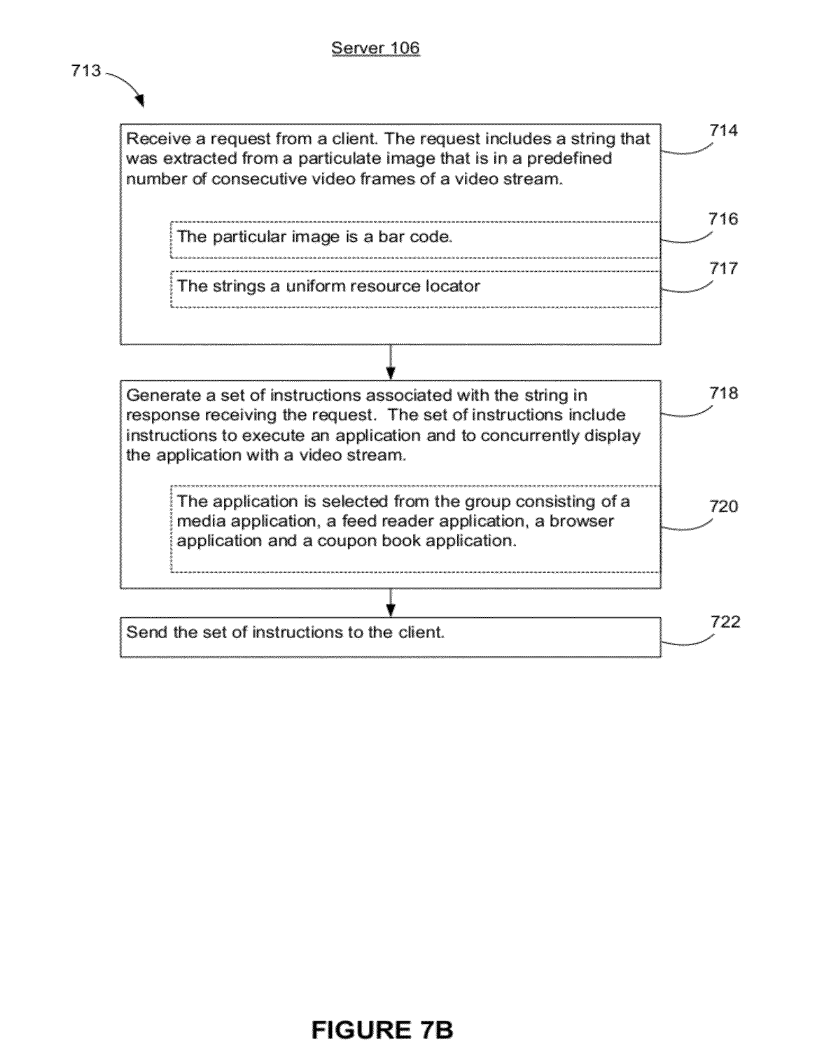

FIG. 4 is a flow diagram illustrating a process 400 of displaying information, according to some implementations. FIG. 4 provides an overview of the methods described in FIGS. 6A, 6B, 7A and 7B. The broadcast system 108 sends a video stream to the client 102 (401). The video stream is received by the client 102 (402). A particular image is detected within the video stream (404). A string associated with the particular image is determined (406). A request including the string is sent to the server 106 (408). The server 106 receives the request including the string (410). The server 106 determines a set of instructions relating to the string (410) and sends the set of instructions to the client 102 (414). The client 102 receives the set of instructions that relate to the string (412) and executes the set of instructions (416).

FIGS. 5A, 5B, 5C, 5D and 5E illustrate exemplary screen shots according to some implementations. FIGS. 5B, 5C, 5D and 5E illustrate applications that are executed by a client device 102. The applications in FIGS. 5B, 5C, 5D and 5E are invoked and controlled by a set of instructions determined based on information encoded in bar code 504 contained in video stream 502. As discussed in greater detail in the discussion of FIGS. 6A and 6B, the image detection module 324 on a client device 102 detects the bar code 504 contained in the video stream 502, decodes the bar code 504, sends a request containing the decoded information to the server 106 to obtain a set of instructions, receives the set of instructions and invokes one or more applications in accordance with the set of instructions. The illustrations in FIGS. 5A, 5B, 5C, 5D and 5E should be viewed as exemplary but not restrictive in nature.

FIG. 5A illustrates a screen shot displaying a video stream 502 that includes a bar code 504. The duration for which that the bar code 504 is displayed depends on the number of frames of the video stream that the bar code 504 is in.

FIG. 5B illustrates a feed reader application 506 displayed adjacent to a video stream 502. In the context of FIG. 5B, the image detection module 324 on the client device 102 detects the bar code 504 contained in the video stream 502, decodes the bar code 504 to obtain decoded information, sends a request containing the decoded information to a server 106 to obtain a set of instructions, receives the set of instructions and invokes the feed reader application 506 on the client device 102 in accordance with the set of instructions. The feed reader application 506 displays a content feed 508. One or more content items 510 in the content feed 508 are selected and displayed based on information derived from the bar code 504 contained in the video stream 502. For example, a user may be watching a sporting event 502 that includes a bar code 504 encoded with information relating to the sporting event. When the display 313 displays the portion of the video stream containing the bar code 504, the feed reader application 508 is invoked on the client device 102 and a content relating to sports such as Sports Headline 1 510 is displayed.

FIG. 5C illustrates a media player 512 displayed concurrently with a video stream 502. In the context of FIG. 5C, the image detection module 324 on the client device 102 detects the bar code 504 contained in the video stream 502, decodes the bar code 504 to obtain decoded information, sends a request containing the decoded information to a server 106 to obtain a set of instructions, receives the set of instructions and invokes the media player application 512 on the client device 102 in accordance with the set of instructions. The set of instructions causes the media player 512 to perform one or more operations such as prompting a user to add a song to the user's playlist. For example, a broadcaster or content provider may insert a bar code 504 into a television show that causes a song to be added to a user's playlist when the user views the television show. When the user views the portion of the video stream containing the bar code 504, the media application 512 associated with the bar code 504 is invoked and the user is prompted to add a song to the user's playlist.

FIG. 5D illustrates a web browser 516 displayed adjacent to a video stream 502. In the context of FIG. 5D, the image detection module 324 on the client device 102 detects the bar code 504 contained in the video stream 502, decodes the bar code 504 to obtain decoded information, sends a request containing the decoded information to a server 106 to obtain a set of instructions, receives the set of instructions and invokes the web browser 516 on the client device 102 in accordance with the set of instructions. In some implementations, the web page 514 displayed in the browser 516 is chosen based on information derived from the bar code 504. For example, a bar code encoded with the URL of a web page containing information about a movie may be inserted into a scene of the movie. In another example, a bar code may be inserted into a pearl milk tea commercial to cause a webpage with information about pearl milk tea to be displayed. The browser application 516 is invoked and the web page 514 is displayed when a user views the portion of the video stream 502 containing the bar code 504.

FIG. 5E illustrates a coupon book application 518. In the context of FIG. 5E, the image detection module 324 on the client device 102 detects the bar code 504 contained in the video stream 502, decodes the bar code 504, sends a request containing the decoded information to the server 106 to obtain a set of instructions, receives the set of instructions and invokes the coupon book application 518 on the client device 102 in accordance with the set of instructions. For example, a commercial can be displayed about a product, where the commercial includes one or more bar codes. While the user views the commercial, the coupon application is invoked and a prompt to the user is displayed to save a coupon to the user's coupon book.

FIGS. 6A and 6B illustrate a method 600 for displaying information to users. Such methods provide an effective way for broadcasters and content providers to provide information relevant to a video stream while the video stream is played.

Attention is now directed to FIG. 6A, which is a flow diagram illustrating a method 600 of displaying information. The method 600 is performed at a client device 102 having one or more processors and memory. A video stream is displayed on a display of the client device 102 (602). For example, the client device 102 may receive and display a video stream corresponding to a television program, commercial or a movie. In some implementations, the video stream is stored on the client device 102. In some implementations, the video stream is received by the video input device 350, the TV tuner 352 or the network interface 308 of the client device 102. In some implementations, the video stream is received from a broadcast system 108.

A particular image in the video stream is detected (604). In some implementations, the particular image is an encoded image. In some implementations, the particular image is detected while the video stream is displayed on the client device 102. In some implementations, the particular image is detected from a video stream that was entirely stored on the client device prior to the video stream being displayed on the client device. In some implementations, the particular image is detected from a video stream that, at least a portion of which, is currently being received by the client device. For example, the video stream is received from a television tuner, cable box, satellite television connection or internet streaming connection. The particular image is detected automatically and without any user action. For example, a user does not have to initiate a bar code scanning application or select a user interface element to initiate image detection. In some implementations, the video stream includes a plurality of consecutive image frames and the particular image is detected at a display position in a predefined number of consecutive frames (606). The display position of the particular image is the position of the image when the video stream is displayed. For example, as shown in FIG. 5A, the bar code 504 is displayed in the upper right corner of the screen when the video stream 502 is displayed. The particular image can be located at any display position. For example, the particular image can be located along the top, bottom or sides of the predetermined number of video frames of the video stream. To be detected, the particular image is displayed at the same display position for a predefined number of video frames. In some implementations, the particular image is a bar code (608). One or more particular images may be detected in the same group of consecutive frames. For example, there may be multiple bar codes placed at different display positions in a 30 second commercial. In some implementations, the image detection module 324 only analyzes certain display portions of a video stream for particular images. For example, the image detection module 324 may only analyze the top, bottom or sides of a frame or frames to detect a particular image. By analyzing certain display portions of a video stream, the image detection module 324 uses less processing resources and detects images faster. As discussed in more detail herein, the particular image includes encoded information relating to the image frames that the particular image is contained in. As discussed above, the image detection module 324 of the client 102 detects the particular image or images.

A string associated with the detected particular image is determined (610). In some implementations, the string consists of alphabet characters, numbers or any combination thereof. In some implementations, the string includes a uniform resource locator (612). In some implementations, the string includes a shortened uniform resource locator. Uniform resource locator shortening is a technique used to reduce the characters a URL has. A shortened URL links to a longer URL using an HTTP redirect on a domain name. In some implementations, the determining includes decoding the particular image into the string (614). In some implementations, the particular image is associated with a plurality of strings and the determining includes determining a plurality of strings from the detected image. As discussed above, the image detection module 324 decodes the particular image to obtain the string or strings (e.g., decoded information 360). The decoded string or strings are stored on the client 102 as decoded information 360.

A content provider may include metadata into a video by inserting an encoded image into the video. For example, a bar code displayed during a particular scene in movie may contain a URL to a website that includes more information about the people, places, or things in the particular scene. By inserting encoded images into a particular segment of a video, a content provider can provide information relevant to the video segment while the video segment is played.

After the string associated with the particular image is determined, a request 236 is sent to a server 106 (616). The request 236 includes the determined string (616). In some implementations, when a plurality of strings is decoded from the particular image, the request 235 includes the plurality of strings. The request 236 is sent to the server 106 to obtain a set of instructions 234. In some implementations, the request 236 is generated and sent to the server 106 automatically and without any user interaction. For example, a user does not need to initiate the sending of the request after the particular image is detected. The request 236 is generated and sent by the request module 361.

In some implementations, the request 236 is not sent to the server 106 and instead a message, the content of which is determined based on the string, is displayed by message module 362. For example, the string or strings may include one or more symbols, characters or numbers that instruct the request module 361 to display a message instead of sending the request 236 to the server 106. The displayed message includes at least a portion of the string or strings. In some implementations, an email message or SMS message is sent to a user associated with the client 102. The email or SMS message includes at least a portion of the one or more strings.

A set of instructions 234 is received from the server 106 (618). The set of instructions 234 relate to the determined string (618). The set of instructions include instructions to execute an application and to display the executed application concurrently with the video stream. In some implementations, when a plurality of strings is decoded from the particular image, the set of instructions 234 relate to the plurality of strings. In some implementations, the set of instructions 234 is received in response to sending the request 236. In some implementations, the set of instructions 234 is contained in a content feed. The set of instructions 234 is received by the image detection module 324.

The image detection module 234 parses the set of instructions 234 to identify one or more applications to execute. For example, when the set of instructions 234 includes a URL, a browser application is chosen for execution or the URL may link to a document that identifies an application to execute. In some implementations, the set of instructions 234 includes a URL to a document that includes instructions to execute. In some implementations, the set of instructions 234 includes an indication of the associated application. For example, the set of instructions 234 may consist of a name of an application, a symbol that acts as a separator and a set of instructions for the application corresponding to the name of the application.

One or more functions and/or applications are executed in accordance with the set of instructions 234. In some implementations, an application is executed in accordance with the set of instructions 234 in response to receiving the set of instructions 234 (620). In some implementations, a plurality of applications is executed in accordance with the set of instructions 234. In some implementations, the application or applications are automatically executed without any user action. For example, a user does not need to confirm or select an application. Any application compatible with the set of instructions 234 may be executed. In some implementations, the one or more applications are selected from the group consisting of a media application, a feed reader application, a browser application and a coupon book application (622). For example, as shown in FIG. 5C, the set of instructions 234 include instructions to invoke a media player application 512 and prompt a user to add a song to the user's playlist. The one or more applications are executed by the image detection module 324.

In some implementations, the executed application or applications and the video stream are displayed on the display of the client device 102 (624). In some implementations, the executed application is displayed adjacent to the video stream on the display of the client device 102. For example, as shown in FIG. 5C, a media player application 512 is displayed concurrently with a video stream 502. In some implementations, the executed application or applications are displayed on a second client device (626). In other words, the video stream and the application are displayed on separate devices. For example, the executed application or applications may be displayed on a tablet device while the video stream is displayed on a television. By concurrently displaying both the executed application or applications and the video stream, a user can operate the application or applications while continuing to watch the video stream. For example, the second client device may display a web page containing information relating to the content of the video stream playing on the first client device.

In some implementations, the set of instructions 234 includes instructions to display a message. The content of the message is related to the one or more strings. For example, a URL for a product's website may be displayed or a snippet of information relating to a television program may be displayed. In some implementations, the set of instructions 234 includes instructions to send a message (e.g., email or SMS) to a user associated with the client. For example, the message may include a coupon, a link to a coupon, a song, a link to a song, information about a television program or movie and links to information. The message module 362 displays and sends messages.

A content provider may add metadata to a video by inserting an encoded image (e.g., a bar code) into the video. As discussed above, one or applications are invoked while a video segment containing the encoded image (e.g., bar code) is being played. More specifically, the image detection module 324 on the client device 102 detects an encoded image in a video stream, decodes the image to obtain decoded information 360, sends a request 236 containing the decoded information 360 to the server 106 to obtain a set of instructions 234, receives the set of instructions 234 and executes one or more applications in accordance with the set of instructions 234.

FIG. 7A is a flow diagram illustrating a method 700 of inserting metadata into a video stream. As discussed above, content providers and broadcasters can provide relevant information to viewers by inserting metadata into video streams. The method 700 is performed at a broadcast system 108 with one or more processors and memory. Method 700 may be performed at a server system that combines the functionality of server system 106 and broadcast system 108. A video stream for transmission is prepared (702). In some implementations, the video stream is retrieved from the video stream database 268 by the image module 264. The preparing includes inserting a particular image into the video stream forming a modified video stream (704). The particular image is associated with a string (704). In some implementations, the particular image encodes a string. In some implementations, the particular image encodes a plurality of strings. In some implementations, the particular image is a bar code. The image module 264 identifies the particular image from an entry in the insertion table 271 that corresponds to the video stream, retrieves the image from the image database 266 and inserts the image into the video stream to form the modified video stream. In some implementations, the image module 264 inserts multiple images into the video stream. The information in the insertion table 271 is provided by broadcasters and/or content providers.

In some implementations, the inserting includes inserting the particular image into a predefined number of consecutive frames of the video stream at a particular display position. The particular image is inserted into a minimum number of frames of a video stream in order for the particular image to be detected when the video stream is displayed. For example, the particular image may be inserted into 400 consecutive image frames at the same display position.

The modified video stream is formatted to concurrently display the video stream and the particular image (704). For example, as shown FIG. 5A, the particular image 504 is displayed concurrently with the video stream 502. In some implementations, the particular image is a bar code (706). In some implementations, the particular image is associated with a plurality of strings (707).

In some implementations, the particular image is encoded to contain information corresponding to the string (708). A high contrast images such as a bar codes contains an arrangement of black modules on a white background that encodes text information. In some implementations, the information includes one or more strings consist of alphabet characters, numbers or any combination thereof. In some implementations, the one or more strings include a uniform resource locator (710). The one or more strings are associated with content that relates to the group of video frames that the corresponding particular image is inserted into. For example, a bar code displayed in a tea commercial may include the encoded URL for the tea maker's website. For example, a bar code displayed during a particular scene in a movie may contain an encoded URL for a website that includes more information about the people, places, or things in the particular scene.

In some implementations, the string or strings include instructions to execute one or more applications. In some implementations, the one or more applications are selected from the group consisting of a media application, a feed reader application, a browser application and a coupon book application. In some implementations, the string or strings includes instructions that when executed by a first client device causes one or more applications on a second client device to be executed. In some implementations, the string or strings include the names of people, places or things.

The modified video is transmitted to a client 102 (712). The modified video is transmitted by the image module 264 or the front end server 140.

FIG. 7B is a flow diagram illustrating a method 713 of generating a set of instructions 234. The method 713 is performed at a server system 106 having one or more processors and memory. Method 713 may be performed at a server system that combines the functionality of server system 106 and broadcast system 108. A request 236 is received from a client 102 (714). The request 236 includes a string 240 that was extracted from a particular image that is in a predefined number of consecutive video frames of a video stream (714). In some implementations, the request 236 includes a plurality of strings. In some implementations, the string or strings were extracted from a plurality of images that are in a predefined number of consecutive video frames of a video stream. In some implementations, the request 234 includes a user identifier 238. In some implementations, the particular image is at a particular display position in the predefined number of consecutive video frames. In some implementations, the particular image is a bar code (716). In some implementations, the string includes a URL (717). The request 236 is received by the instruction module 116.

A set of instructions 234 associated with the string is generated in response to receiving the request 236 (718). In some implementations, the set of instructions 234 is generated based on the string 240. In some implementations, the string 240 specifies a URL and the generated set of instructions 234 includes instructions extracted from the document specified by the URL. In some implementations, one or more relevant identities 290 are identified using the strings 240. For example, the instruction module 116 may query the identity database 118 using the strings 240 as queries. As discussed above, the identities 290 may correspond to people, places or things. For example, an identity 290 could be an actor, a product, a country or a company. Each of the identified relevant identities 290 has one or more associated actions. The instruction module 116 selects one or more of the identified relevant identities 290 and generates the set of instructions 234 based on the associated actions of the selected one or more identities. In some implementations, the associated actions for an identity include executing one or more applications. In some implementations, the instruction module 116 uses the selected identities to determine one or more content files in the content database 118 to send to the client 102 corresponding to the request 236. In some implementations, the instruction module 116 generates the set of instructions 234 in part on user data 226 for a particular user. For example, a user may prefer to not receive coupon offers.

In some implementations, the set of instructions 234 includes instructions for executing an application selected from the group consisting of a media application, a feed reader application, a browser application and a coupon book application (720). In some implementations, the set of instructions 234 includes instructions that when executed by a first client device, executes one or applications on a second client device.

In some implementations, the set of instructions 234 includes instructions to display a message on the client device 102. The content of the message is related to the one string 240. For example, a URL for a product's website may be displayed or a snippet of information relating to a television program may be displayed. In some implementations, the set of instructions 234 includes instructions to send a message (e.g., email or SMS) to a user associated with the client 102. For example, the message may include a coupon, a link to a coupon, a song, a link to a song, information about a television program or movie and links to information.

The set of instructions 234 are sent to the client 102 (722). In some implementations, the set of instructions 234 is sent in a content feed. In some implementations, one or more content files are sent along with the set of instructions 234. For example, a playlist, media file, advertisement or feed stored in the content database 118 may be sent to the client 102 along with the set of instructions 234. As discussed above, the set of instructions 234 and optionally the one or more content files are sent by the instruction module 116.

Each of the methods described herein may be governed by instructions that are stored in a non-transitory computer readable storage medium and that are executed by one or more processors of one or more servers (e.g., server system 106). Each of the operations shown in FIGS. 6A, 6B, 7A and 7B may correspond to instructions stored in a computer memory or computer readable storage medium.

The foregoing description, for purpose of explanation, has been described with reference to specific implementations. However, the illustrative discussions above are not intended to be exhaustive or to limit the methods and systems to the precise forms disclosed. Many modifications and variations are possible in view of the above teachings. The implementations were chosen and described in order to best explain the principles of the methods and systems and their practical applications, to thereby enable others skilled in the art to best utilize the ideas and various implementations with various modifications as are suited to the particular use contemplated.

Moreover, in the foregoing description, numerous specific details are set forth to provide a thorough understanding of the present description. However, it will be apparent to one of ordinary skill in the art that the methods described herein may be practiced without these particular details. In other instances, methods, procedures, components, and networks that are well known to those of ordinary skill in the art are not described in detail to avoid obscuring aspects of the ideas presented herein.

What is claimed is:

1. A method comprising:
at a system having one or more processors and memory storing one or more programs to be executed by the one or more processors:
receiving a request from a client, the request including a string that was extracted from a particular image that is in a predefined number of consecutive video frames of a video stream;
in response to receiving the request, generating a set of instructions associated with the string, wherein the set of instructions include instructions to execute an application and to concurrently display the application with a video stream; and
sending the set of instructions to the client.
